(19) United States
(12) Patent Application Publication
(10) Pub. No.: US 2016/0048409 A1
(43) Pub. Date: Feb. 18, 2016

(54) SYSTEM AND METHOD FOR AUTOMATIC INITIATION AND MANAGEMENT OF A GUEST OPERATING SYSTEM WHICH ENABLES A RESTRICTION OF ACCESS TO THE HOST MACHINE

(71) Applicants: Peter Briel, Miami, FL (US); Thadeus Monrose, Tamarac, FL (US)

(72) Inventors: Peter Briel, Miami, FL (US); Thadeus Monrose, Tamarac, FL (US)

(21) Appl. No.: 14/825,113

(22) Filed: Aug. 12, 2015

Related U.S. Application Data
(60) Provisional application No. 62/036,343, filed on Aug. 12, 2014.

(51) Int. Cl. G06F 9/455; G06F 9/54

(52) U.S. Cl. CPC G06F 9/45558; G06F 9/541; G06F 2009/45575

(57) ABSTRACT

A method of initiating and managing a virtual machine guest operating system which confines user interaction on a host computer to the guest operating system which is implemented on the host computer through software programs stored on a removable, non-volatile storage medium. In one embodiment, the storage medium includes a discrete alpha partition containing software through which the host computer initially boots and which is operative to immediately run a virtual machine and a discrete beta partition which includes a guest operating system and kiosk application software which are automatically run in the virtual machine. The storage medium is thereby configures the host computer to set up and run an alternative operating system and runtime environment which restricts all user interface activity on the host computer to the alternative operating system environment.

### CROSS REFERENCE TO RELATED APPLICATIONS

This application claims the benefit of and incorporates by reference co-pending U.S. provisional patent application Ser. No. 62/036,343 filed Aug. 12, 2014.

### BACKGROUND OF THE INVENTION

1. Field of the Invention

This invention relates generally to guest operating system initiation and management and, more particularly, to a system and method for automatic initiation and management of a guest operating system which enables access to the host operating system and machine to be restricted.

2. Description of the Prior Art

The use and operation of virtual machines to create a software platform on a host computer is well established. Virtual machines are often created and run by a hypervisor for the purpose of creating a virtual operating platform and managing the execution of guest operating systems on thereon. Hypervisors, which may run directly on the host computer hardware or on a host operating system loaded directly on the host computer, commonly allow for one or more virtual machines to be set up on a single physical machine and for them to be selectively used simultaneously along with the (actual) host machine. A problem which still exists, however, is that existing hypervisors and virtual operating platforms often lack the ability to automatically initiate a guest operating system and contain all user interaction within the guest operating system. Thus, there remains a need for a system and method for initiating and managing a virtual machine guest operating system which starts automatically, restricts all access to the host operating system, and limits host machine outputs to guest operating system activity. It would be helpful for such a system and method for initiating and running a guest operating system with host access restriction was configured to run immediately once the host operating system finished booting. It would be additionally desirable for such a system and method to be embodied in bootable computer programs stored on a removable non-volatile computer readable storage medium, enabling any computer to be configured for initiating and running a guest operating system with host access restriction on startup.

The Applicant's invention described herein provides for a system and method for initiating and managing a virtual machine guest operating system which confines user interaction on the host computer to the guest operating system. When in operation, the system and method for initiating and running a guest operating system with host access restriction enables the guest operating system and accompanying applications on a virtual machine to function as kiosk software within the host operating system. As a result, many of the limitations imposed by prior art systems and methods are removed.

### SUMMARY OF THE INVENTION

A method of initiating and managing a virtual machine guest operating system which confines user interaction on a host computer to the guest operating system which is implemented on the host computer through software programs stored on a removable, non-volatile storage medium. In one embodiment, the storage medium is configured with a discrete alpha partition on which a boot loader, a host operating system, and hypervisor software are loaded, with the host operating system and/or the hypervisor software modified to run a virtual machine once initialization is complete and a discrete beta partition which includes a guest operating system which is to be run in the virtual machine, a kiosk application software that is to be automatically run on at the startup of the guest operating system, and any application software which is desired to be availed on the guest operating system. The storage medium is thereby operative to automatically load on the host computer the guest operating system in a virtual machine created by the host operating system and restrict all user interface activity on the host computer to the guest operating system environment.

It is an object of this invention to provide a system and method for initiating and managing a virtual machine guest operating system which starts automatically, restricts all access to the host operating system, and limits host machine outputs to guest operating system activity.

It is another object of this invention to provide a system and method for initiating and running a guest operating system with host access restriction which is configured to run immediately once the host operating system finished booting.

It is yet another object of this invention to provide a system and method for initiating and running a guest operating system to be embodied in bootable computer programs stored on a removable non-volatile computer readable storage medium, enabling any computer to be configured for initiating and running a guest operating system with host access restriction on startup.

These and other objects will be apparent to one of skill in the art.

### BRIEF DESCRIPTION OF THE DRAWINGS

FIG. 1 shows the components of a system and method for initiating and managing a virtual machine guest operating system which confines user interaction on the host computer to the guest operating system built in accordance with the present invention.

FIG. 2 shows the steps through which the virtual machine of a virtual machine guest operating system which confines user interaction on the host computer to the guest operating system is initiated.

FIG. 3 shows the steps through which a virtual machine guest operating system which confines user interaction on the host computer to the guest operating system is initiated and managed.

FIG. 4 shows the steps through which the kiosk application software of a virtual machine guest operating system which confines user interaction on the host computer to the guest operating system is initiated.

### DETAILED DESCRIPTION OF THE INVENTION

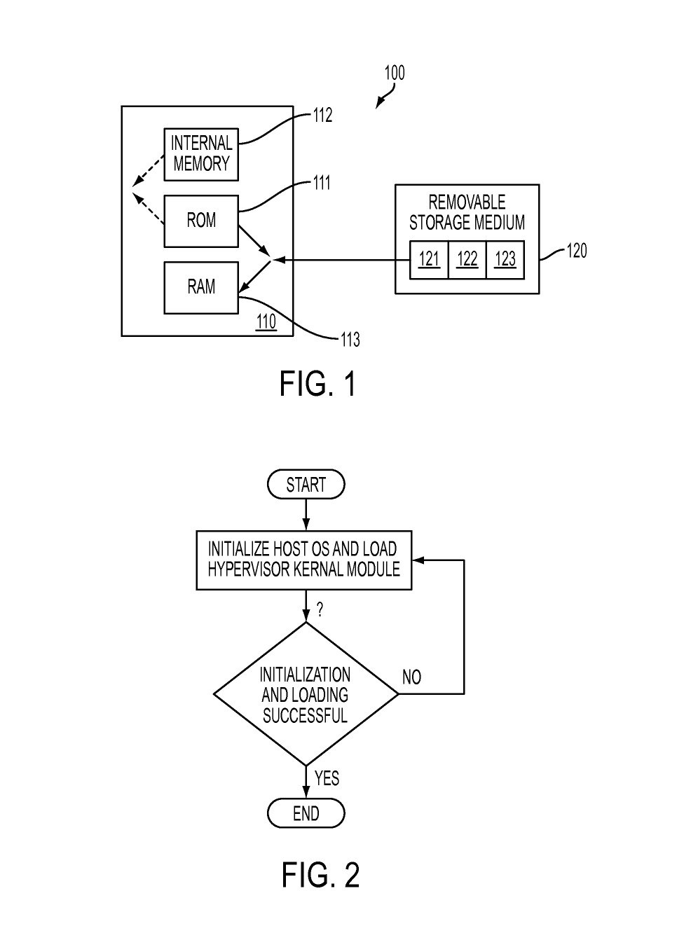

Referring now to the drawings and in particular FIG. 1, a system for initiating and managing a virtual machine guest operating system which confines user interaction on the host computer to the guest operating system 100 in accordance with the present invention includes a host machine 110 and a removable, non-volatile storage medium 120. In the preferred embodiment, the host machine 110 defines a conventional personal computer, such as a desktop computer, laptop or other mobile computer, or all-in-one computer. It is contemplated, however, that in other embodiments the host machine 110 may define any electronic device having a processor and computing capability (or computing device) which utilizes an operating system to manage hardware resources and provide common services for software programs.

As common with conventional computers, when the host machine 110 is powered on, a firmware interface (such as BIOS) stored in read-only memory 111 is operative to load a boot loader or an operating system (“OS”) and transfer software execution tasks thereto. As conventional firmware conventionally enables the selection of a boot device, the firmware on a host machine 110 in accordance with the present invention may be configured either (1) to provide a user with the option to boot from the removable storage medium 120 (as opposed to a local OS stored in an internal storage medium 112) or (2) to automatically boot from the removable storage medium 120 when the removable storage medium 120 is accessible when the host machine 110 is powered on.

In the preferred embodiment, the removable storage medium 120 is a Universal Serial Bus (“USB”) flash memory stick (or “flash drive”) having three discrete partitions. It is understood, however, that any removable, non-volatile data storage device may be employed as the removable storage medium 120.

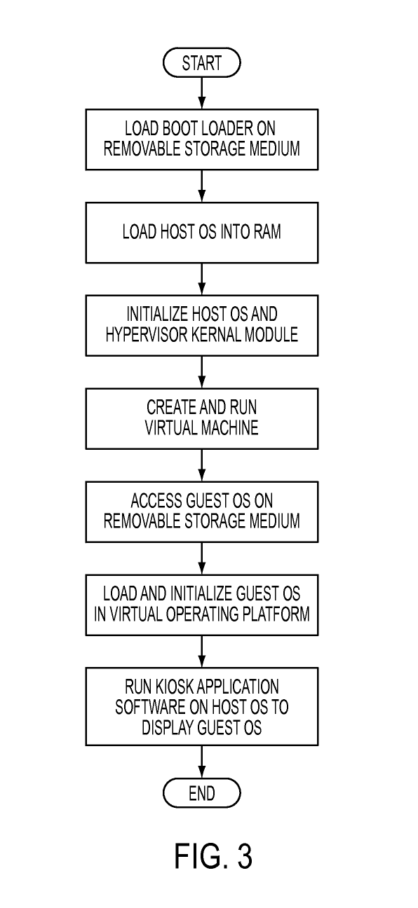

The first partition 121 includes a boot loader, a host operating system, and hypervisor software, with the host operating system and/or the hypervisor software modified to run a virtual machine once initialization is complete. In the preferred embodiment of the present invention, the GNU GRand Unified Bootloader (“GNU GRUB”) defines the boot loader, a Linux OS using the Linux Kernel defines the host operating system, and the hypervisor software is the Kernel-based Virtual Machine (“KVM”). It is understood, however, that another second stage boot loader may be used in the alternative to the GNU GRUB and other operating system/hypervisor (including native or hosted hypervisors) combinations may be used. It is further recognized that as KVM requires a processor with hardware virtualization extension, the processor of the host machine 110 in accordance with the present invention must include said extension in KVM embodiments. When the host machine 110 is powered on with the removable storage medium 120 designated as the boot device, the software on the first partition 121 enables the loading of the GNU GRUB, the Linux operating system, and the KVM as a kernel module thereof into the host machine's 110 random access memory 113 (“RAM”) as detailed in FIG. 3 and below.

The second partition contains the OS and delta files with all configurations. It also contains the program necessary to repair the first partition.

The third partition 123 includes a guest operating system which is to be run in the virtual machine run by the software in the first partition 121, application software that is to be automatically run on at the startup of the guest operating system, and application software which is desired to be availed on the guest operating system. In the preferred embodiment, the guest operating system is defined as Microsoft Windows 7. It is recognized, however, that other operating systems can be used in the alternative thereto.

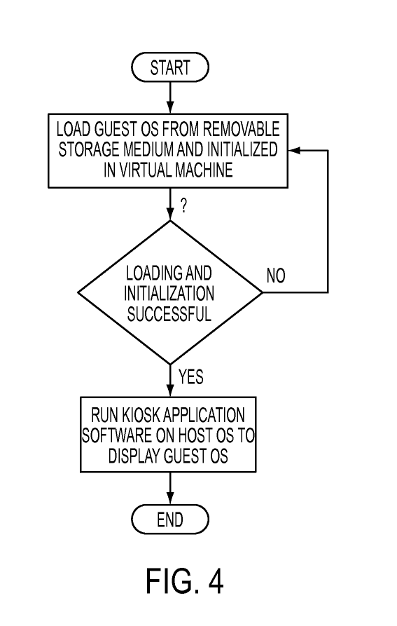

Referring now to FIGS. 2, 3, and 4, in the preferred embodiment, the process for initiating and managing a virtual machine guest operating system which confines user interaction on the host computer to the guest operating system begins with the host computer being powered on with the USB memory stick accessible as the boot device. The firmware of the host computer may be configured to automatically select the USB memory stick as the boot device or enable a user to select it as the boot device. In this regard, on startup, the firmware causes the processor of the host computer to load the GNU GRUB from the first partition of the USB memory stick. Once loaded, the GNU GRUB causes the processor to load the Linux OS software from the first partition of the USB memory stick in to the RAM of the host computer. The Linux OS software then initializes the Linux OS and loads the KVM kernel module.

In accordance with the present invention, the Linux OS and the KVM on the first partition of the USB memory stick are modified through software containing a set of instructions that, when executed by a processor, cause the processor to (1) query the initialization of the Linux OS and the KVM, (2) run a Windows 7 OS virtual machine once the initialization succeeds, and (3) boot the Windows 7 OS in the virtual machine. Consequently, as soon as the initialization of the Linux OS and the KVM is determined to have succeeded, the KVM runs a virtual machine, accesses the Windows 7 OS on the third partition of the USB memory stick, and loads and initializes the Windows 7 OS in the virtual operating platform provided by the virtual machine.

After the Windows 7 OS is loaded and initialized in the virtual machine, a kiosk application software is loaded and run on the Linux OS from the USB memory stick. As with conventional kiosk software, the kiosk application software contain of instructions that, when executed by a processor, cause the processor lock down the operating system environment, allowing limited permissions and program access, as well as provide for remote access and control functions such as monitoring and tracking of activity, preparing activity reports, uploading data such as usage statistics, generating email or text alerts, preparing reports generated in response to problems detected by the software, and allowing for remote updates. In accordance with the lock down of the operating system environment, the operation of the kiosk application software results in a complete overlay of the Windows 7 OS on the Linux OS, effectively containing all user interaction within the guest operating system. This includes all data from input hardware devices, such as a keyboard (physical or virtual) or mouse, and all data output hardware devices, such as a video monitor or printer. In other words, all mouse clicks or buttons pushed on an input device are operative solely in the Windows 7 OS; and the graphical user interface (“GUI”) generated by the Windows 7 OS fully obscures any GUI of the Linux OS. Consequently, a user of a host computer running the Windows 7 OS in a virtual machine in accordance with the present invention does not see or interact with the Linux OS, making the Windows 7 OS in the virtual machine appear as if it is sole operating system on the host computer.

It is understood that any additional software programs that are desired to be availed to a user of the host computer in the Windows 7 OS virtual machine may be stored on the third partition so that they can be accessed through the Windows 7 OS virtual machine. Because of the kiosk application software, software programs on the host computer's internal storage medium or the first partition will not be available (files on the computer's internal storage medium or available on networked location, however, may be available if the kiosk permissions enable a user to access outside (as in not on partition three) files.

It is appreciated that because the host operating system, hypervisor, and the guest operating system (as well as its software components), are embodied on a removable storage medium, a given computer can be selectively used as a system for initiating and running a guest operating system with host access restriction in accordance with the present invention by connecting the removable storage medium to the computer prior to powering it on, or used with its own internal components by disconnecting the removable storage medium from the computer prior to powering it on.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A method of initiating and managing an alternative operating system on a host computer which limits the activity on the host computer to the alternative operating system environment, comprising the steps of:
availing to a host computer having a host processor and a non-transitory memory a removable, non-volatile storage medium which includes software containing instructions executable by a computer processor;
loading and initializing by said host processor a host operating system on the host computer, wherein said host operating system is loaded and initialized using software stored on said storage medium;
creating and running by said host processor a virtual machine in the host operating system, wherein said virtual machine is created and run using software stored on said storage medium; and
loading and initializing by said host processor a guest operating system in the virtual machine, wherein said guest operating system is loaded and initialized using software stored on said storage medium.

2. The method of claim 1, additionally comprising the step of loading and running by said host processor a kiosk software application in the host operating system operative to restrict all user interface activity on the host computer within the guest operating system.

3. The method of claim 2, wherein said kiosk software application is retrieved from said storage medium prior to being run.

4. The method of claim 1, additionally comprising the step of loading by said host processor a boot loader on the host computer so as to enable the step of loading and initializing the host operating system, wherein said boot loader is loaded and initialized using software stored on said storage medium.

5. The method of claim 1, wherein said storage medium includes at least a discrete alpha partition and a discrete beta partition.

6. The method of claim 5, wherein the software used to load and initialize the host operating system is stored in said alpha partition.

7. The method of claim 6, additionally comprising the step of loading by said host processor a boot loader on the host computer so as to enable the step of loading and initializing the host operating system, wherein said boot loader is loaded and initialized using software stored in said alpha partition.

8. The method of claim 6, wherein the software used to load and initialize the host operating system is stored in said beta partition.

9. The method of claim 8, additionally comprising the step of loading and running by said host processor a kiosk software application in the host operating system operative to restrict all user interface activity on the host computer within the guest operating system.

10. The method of claim 9, wherein said kiosk software application is retrieved from said beta partition prior to being run.

11. A non-volatile storage medium operative to automatically initiate and manage an alternative operating system on a host computer which limits the activity on the host computer to the alternative operating system environment, comprising:
a non-volatile storage medium which includes software containing instructions executable by a computer processor, wherein said storage medium is configured to be selectively coupled with a host computer having a host processor and a non-transitory memory and the software causes the host processor to perform the following steps;
load and initialize a host operating system on the host computer using software stored on said storage medium;
create and run a virtual machine in the host operating system using software stored on said storage medium; and
load and initialize a guest operating system in the virtual machine using software stored on said storage medium.

12. The non-volatile storage medium of claim 11, wherein the software on said storage medium additionally causes the host processor to load and run a kiosk software application in the host operating system operative to restrict all user interface activity on the host computer within the guest operating system.

13. The non-volatile storage medium of claim 11, wherein the software on said storage medium additionally causes the host processor to load a boot loader on the host computer so as to enable the loading and initializing of the host operating system.

14. The non-volatile storage medium of claim 11, wherein said storage medium includes at least a discrete alpha partition and a discrete beta partition.

15. The non-volatile storage medium of claim 14, wherein the software which causes the loading and initializing of the host operating system is stored on said alpha partition.

16. The non-volatile storage medium of claim 14, wherein the software on said storage medium additionally causes the host processor to load a boot loader on the host computer so as to enable the loading and initializing of the host operating system, wherein said boot loader is loaded and initialized using software stored on said alpha medium.

17. The non-volatile storage medium of claim 16, wherein the software which causes the loading and initializing of the host operating system is stored on said beta partition.

18. The non-volatile storage medium of claim 17, wherein the software on said storage medium additionally causes the host processor to load and run a kiosk software application in the host operating system operative to restrict all user interface activity on the host computer within the guest operating system.

19. The non-volatile storage medium of claim 18, wherein said kiosk software application is retrieved from said beta partition prior to being run.

20. A method of initiating and managing an alternative operating system on a host computer which limits the activity on the host computer to the alternative operating system environment, comprising the steps of:
availing to a host computer having a host processor and a non-transitory memory a removable, non-volatile storage medium which includes software containing instructions executable by a computer processor, wherein said storage medium includes at least a discrete alpha partition and a discrete beta partition;
loading by said host processor a boot loader on the host computer so as to enable the step of loading and initializing the host operating system, wherein said boot loader is loaded and initialized using software stored in said alpha partition;
loading and initializing by said host processor a host operating system on the host computer, wherein said host operating system is loaded and initialized using software stored in said alpha partition;
creating and running by said host processor a virtual machine in the host operating system, wherein said virtual machine is created and run using software stored in said alpha partition;
loading and initializing by said host processor a guest operating system in the virtual machine, wherein said guest operating system is loaded and initialized using software stored in said beta partition; and
loading and running by said host processor a kiosk software application in the host operating system operative to restrict all user interface activity on the host computer within the guest operating system, wherein said kiosk software application is retrieved from said beta partition prior to being run.
